(19) United States
(12) Patent Application Publication
(10) Pub. No.: US 2025/0150943 A1
(43) Pub. Date: May 8, 2025

(54) INDICATING SYSTEM INFORMATION MODIFICATION IN INTER-CELL OPERATION

(71) Applicant: Nokia Technologies Oy, Espoo (FI)

(72) Inventors: Timo KOSKELA, Oulu (FI); Jorma Johannes KAIKKONEN, Oulu (FI); Mihai ENESCU, Espoo (FI)

(21) Appl. No.: 18/706,857

(22) PCT Filed: Oct. 10, 2022
(86) PCT No.: PCT/EP2022/078017

§ 371 Date: May 2, 2024

(30) Foreign Application Priority Data
Nov. 3, 2021 (FI) 20216134

(51) Int. Cl. H04W 48/12; H04W 36/00; H04W 68/02

(52) U.S. Cl. CPC H04W 48/12; H04W 36/0061; H04W 68/02

(57) ABSTRACT

Disclosed is a method comprising receiving, by a terminal device, a message provided by a cell associated with a different physical cell identifier than a physical cell identifier of a serving cell of the terminal device, wherein the message comprises an indication related to system information modification for at least one of the serving cell or the cell associated with the different physical cell identifier; and determining, by the terminal device, based at least partly on the message, the system information modification for at least one of the serving cell or the cell associated with the different physical cell identifier.

### FIELD

The following exemplary embodiments relate to wireless communication.

### BACKGROUND

A terminal device may be configured to monitor paging information on a cell other than the serving cell of the terminal device. There is a challenge in how to configure the terminal device to interpret the paging information, when it is received from a cell other than the serving cell.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: receive a message provided by a cell associated with a different physical cell identifier than a physical cell identifier of a serving cell of the apparatus, wherein the message comprises an indication related to system information modification for at least one of the serving cell or the cell associated with the different physical cell identifier; and determine, based at least partly on the message, the system information modification for at least one of the serving cell or the cell associated with the different physical cell identifier.

According to another aspect, there is provided an apparatus comprising means for: receiving a message provided by a cell associated with a different physical cell identifier than a physical cell identifier of a serving cell of the apparatus, wherein the message comprises an indication related to system information modification for at least one of the serving cell or the cell associated with the different physical cell identifier; and determining, based at least partly on the message, the system information modification for at least one of the serving cell or the cell associated with the different physical cell identifier.

According to another aspect, there is provided a method comprising: receiving, by a terminal device, a message provided by a cell associated with a different physical cell identifier than a physical cell identifier of a serving cell of the terminal device, wherein the message comprises an indication related to system information modification for at least one of the serving cell or the cell associated with the different physical cell identifier; and determining, by the terminal device, based at least partly on the message, the system information modification for at least one of the serving cell or the cell associated with the different physical cell identifier.

According to another aspect, there is provided a computer program product comprising program instructions which, when run on a computing apparatus, cause the computing apparatus to perform at least the following: receiving a message provided by a cell associated with a different physical cell identifier than a physical cell identifier of a serving cell of the apparatus, wherein the message comprises an indication related to system information modification for at least one of the serving cell or the cell associated with the different physical cell identifier; and determining, based at least partly on the message, the system information modification for at least one of the serving cell or the cell associated with the different physical cell identifier.

According to another aspect, there is provided a computer program comprising instructions for causing an apparatus to perform at least the following: receiving a message provided by a cell associated with a different physical cell identifier than a physical cell identifier of a serving cell of the apparatus, wherein the message comprises an indication related to system information modification for at least one of the serving cell or the cell associated with the different physical cell identifier; and determining, based at least partly on the message, the system information modification for at least one of the serving cell or the cell associated with the different physical cell identifier.

According to another aspect, there is provided a computer readable medium comprising program instructions for causing an apparatus to perform at least the following: receiving a message provided by a cell associated with a different physical cell identifier than a physical cell identifier of a serving cell of the apparatus, wherein the message comprises an indication related to system information modification for at least one of the serving cell or the cell associated with the different physical cell identifier; and determining, based at least partly on the message, the system information modification for at least one of the serving cell or the cell associated with the different physical cell identifier.

According to another aspect, there is provided a non-transitory computer readable medium comprising program instructions for causing an apparatus to perform at least the following: receiving a message provided by a cell associated with a different physical cell identifier than a physical cell identifier of a serving cell of the apparatus, wherein the message comprises an indication related to system information modification for at least one of the serving cell or the cell associated with the different physical cell identifier; and determining, based at least partly on the message, the system information modification for at least one of the serving cell or the cell associated with the different physical cell identifier.

According to another aspect, there is provided an apparatus comprising at least one processor, and at least one memory including computer program code, wherein the at least one memory and the computer program code are configured, with the at least one processor, to cause the apparatus to: transmit a message to a terminal device within a cell controlled by the apparatus, wherein the cell controlled by the apparatus is associated with a different physical cell identifier than a physical cell identifier of a serving cell of the terminal device, wherein the message comprises an indication related to system information modification for at least one of the serving cell or the cell associated with the different physical cell identifier.

According to another aspect, there is provided an apparatus comprising means for: transmitting a message to a terminal device within a cell controlled by the apparatus, wherein the cell controlled by the apparatus is associated with a different physical cell identifier than a physical cell identifier of a serving cell of the terminal device, wherein the message comprises an indication related to system information modification for at least one of the serving cell or the cell associated with the different physical cell identifier.

According to another aspect, there is provided a method comprising: transmitting, by a network element of a wireless communication network, a message to a terminal device within a cell controlled by the network element, wherein the cell controlled by the network element is associated with a different physical cell identifier than a physical cell identifier of a serving cell of the terminal device, wherein the message comprises an indication related to system information modification for at least one of the serving cell or the cell associated with the different physical cell identifier.

According to another aspect, there is provided a computer program comprising instructions for causing an apparatus to perform at least the following: transmitting a message to a terminal device within a cell controlled by the apparatus, wherein the cell controlled by the apparatus is associated with a different physical cell identifier than a physical cell identifier of a serving cell of the terminal device, wherein the message comprises an indication related to system information modification for at least one of the serving cell or the cell associated with the different physical cell identifier.

According to another aspect, there is provided a computer program product comprising program instructions which, when run on a computing apparatus, cause the computing apparatus to perform at least the following: transmitting a message to a terminal device within a cell controlled by the apparatus, wherein the cell controlled by the apparatus is associated with a different physical cell identifier than a physical cell identifier of a serving cell of the terminal device, wherein the message comprises an indication related to system information modification for at least one of the serving cell or the cell associated with the different physical cell identifier.

According to another aspect, there is provided a computer readable medium comprising program instructions for causing an apparatus to perform at least the following: transmitting a message to a terminal device within a cell controlled by the apparatus, wherein the cell controlled by the apparatus is associated with a different physical cell identifier than a physical cell identifier of a serving cell of the terminal device, wherein the message comprises an indication related to system information modification for at least one of the serving cell or the cell associated with the different physical cell identifier.

According to another aspect, there is provided a non-transitory computer readable medium comprising program instructions for causing an apparatus to perform at least the following: transmitting a message to a terminal device within a cell controlled by the apparatus, wherein the cell controlled by the apparatus is associated with a different physical cell identifier than a physical cell identifier of a serving cell of the terminal device, wherein the message comprises an indication related to system information modification for at least one of the serving cell or the cell associated with the different physical cell identifier.

According to another aspect, there is provided a system comprising at least a terminal device and a network element of a wireless communication network, wherein the terminal device is within a cell controlled by the network element, wherein the cell controlled by the network element is associated with a different physical cell identifier than a physical cell identifier of a serving cell of the terminal device. The network element is configured to: transmit a message to the terminal device, wherein the message comprises an indication related to system information modification for at least one of the serving cell or the cell associated with the different physical cell identifier. The terminal device is configured to: receive the message from the network element; and determine, based at least partly on the message, the system information modification for at least one of the serving cell or the cell associated with the different physical cell identifier.

According to another aspect, there is provided a system comprising at least a terminal device and a network element of a wireless communication network, wherein the terminal device is within a cell controlled by the network element, wherein the cell controlled by the network element is associated with a different physical cell identifier than a physical cell identifier of a serving cell of the terminal device. The network element comprises means for: transmitting a message to the terminal device, wherein the message comprises an indication related to system information modification for at least one of the serving cell or the cell associated with the different physical cell identifier. The terminal device comprises means for: receiving the message from the network element; and determining, based at least partly on the message, the system information modification for at least one of the serving cell or the cell associated with the different physical cell identifier.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates an example of a system, to which some exemplary embodiments may be applied;

FIGS. 3-5 illustrate signaling diagrams accordin to some exemplary embodiments;

FIGS. 6-7 illustrate flow charts according to some exemplary embodiments;

FIGS. 8-9 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

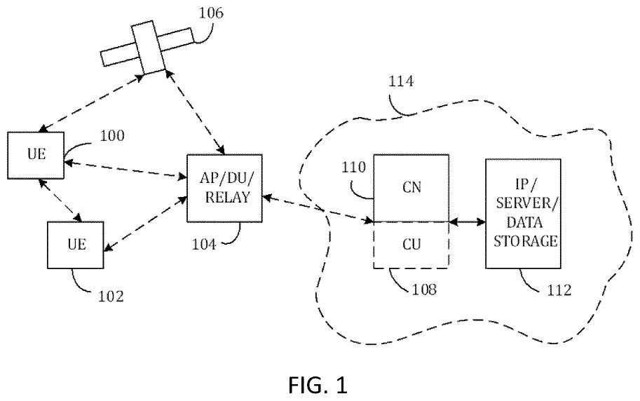

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The (e/g)NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW) for providing connectivity of user devices (UEs) to external packet data networks, mobility management entity (MME), access and mobility management function (AMF), or location management function (LMF), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and UE(s) and/or between the IAB node and other IAB nodes (multi-hop scenario).

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home(e/g)nodeB.

Furthermore, the (e/g)nodeB or base station may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) or a centralized unit that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g)nodeB or base station. The DU may be defined as a logical node hosting radio link control (RLC), medium access control (MAC) and/or physical (PHY) layers of the (e/g)nodeB or base station. The operation of the DU may be at least partly controlled by the CU. The CU may comprise a control plane (CU-CP), which may be defined as a logical node hosting the RRC and the control plane part of the PDCP protocol of the CU for the (e/g)nodeB or base station. The CU may further comprise a user plane (CU-UP), which may be defined as a logical node hosting the user plane part of the PDCP protocol and the SDAP protocol of the CU for the (e/g)nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network, may aggregate traffic from a large number of HNBs back to a core network.

Paging is a mechanism that may be used to initiate communication services for UEs that are in RRC idle state or RRC inactive state. For example, the network may transmit a paging message to a UE in idle/inactive state in order to switch the UE to connected state, when the network needs to transmit downlink data to the UE. Paging may also be used by the network for other purposes, such as providing a short message comprising an earthquake and tsunami warning system (ETWS) notification, a commercial mobile alert system (CMAS) notification, an indication indicating the availability of a system information modification (system information update), and/or an indication indicating the availability of a tracking reference signal (TRS) to the UE. Such a short message may also be referred to as a short paging message.

Thus, the UE may occasionally wake up to monitor whether the network is sending any paging message to it, but the UE has to spend some energy (battery power) to run this monitoring process on those time occasions. However, the UE can conserve its battery power by sleeping during the time when the network is not transmitting paging messages (instead of continuously monitoring for the paging messages).

This kind of reception mechanism may be referred to as discontinuous reception (DRX). During the idle/inactive state, the UE stays in sleep mode according to a DRX cycle, which may also be referred to as a paging cycle. The paging cycle indicates the time interval after which the UE wakes up and monitors for the paging message. The network may indicate the default paging cycle to the UE in system information block type 1 (SIB1), for example. The UE may determine its paging cycle based on the shortest of the UE-specific DRX value(s) (if configured by RRC and/or upper layers), and/or the default paging cycle (default DRX value) broadcast in system information. In RRC idle state, if a UE-specific DRX value is not configured by the upper layers, the default DRX value may be applied.

As a non-limiting example, if the paging cycle is set to 1280 ms (128 radio frames), then the UE may wake up in frame #3, then again in frame #131 (after 128 frames), and then again in frame #259, and so on. The radio frame in which the UE wakes up is called a paging frame (PF). Within a radio frame, there may be 10 subframes. However, the UE may not remain awake in all 10 subframes of the paging frame. Instead, the UE may wake up in a specific subframe, for example subframe 0, 4, 5 or 9, within the paging frame. These specific subframe(s) within a paging frame, when the UE wakes up, are called paging occasions (PO).

The system information may comprise a parameter NB, which depicts the number of paging subframes within the paging cycle. The UE may determine the paging frame based on the paging cycle, the parameter NB, and the UE identity. The UE identity may be based on the international mobile subscriber identity (IMSI) value of the UE. Once the UE has determined the paging frame, it may determine the subframe of the paging frame to wake up on.

Thus, the UE periodically wakes up according to the paging cycle and monitors a physical downlink control channel (PDCCH) for the paging downlink control information (DCI) in order to check for the presence of a paging message on a physical downlink shared channel (PDSCH). The paging DCI comprises the time-frequency allocation of the paging message on the PDSCH. If there is no allocation, the UE determines that it is not paged. If the PDCCH indicates that a paging message is transmitted in the subframe (i.e., if there is an allocation), then the UE proceeds with receiving the paging message on the PDSCH, and demodulates the paging channel (PCH) to see if the paging message is directed to it (the paging message might not be addressed to this specific UE, since there may be multiple UEs using the same paging cycle). If the UE finds its own identity in the paging message, it considers itself paged and may take appropriate action (e.g., sets up an RRC connection).

Some exemplary embodiments relate to inter-cell beam management (BM), which is an enhancement for multi-beam operation in NR MIMO. Some exemplary embodiments may also be applied for inter-cell multiple transmission and reception point (mTRP) communication. Inter-cell beam management (or inter-cell mTRP) means that a given UE may be configured to communicate with one or more additional cells that are different from the serving cell of the UE, while the serving cell is still the same (i.e., the serving cell does not change when beam selection is done).

The above operation may be referred to as dynamic point selection (DPS). The serving cell of the UE does not change in inter-cell beam management, but the UE may be configured and indicated to receive at least dedicated channels from a cell with a different physical cell identifier (PCI) than the PCI of the serving cell, while still maintaining the serving cell connection. A UE capable of such an operation may be referred to as an inter-cell BM UE herein. PCI is an identifier that may be used to distinguish different cells from one another.

In any of the exemplary embodiments herein, the cell configured for the inter-cell BM (or inter-cell mTRP) that is additional to the serving cell of the UE, may be referred to as a cell with a different PCI than the serving cell, different cell than serving cell, alternative cell, additional cell, assisting cell, inter-cell BM cell, alternative PCI, additional PCI, a non-serving cell, and so on.

With respect to the monitoring of different channels in inter-cell beam management, the paging channel monitoring in inter-cell beam management operation may be performed according to one of the following three alternatives.

In a first alternative, the UE may not be required to monitor for paging and short messages associated with the newly indicated transmission configuration indicator (TCI) state associated with a PCI different from the serving cell. This means that the UE paging monitoring is not affected by the inter-cell beam management operation in this alternative. In other words, in this alternative, the UE does not monitor P-RNTI on the cell with a different PCI, although it may monitor a UE-specific search space (USS) and/or dedicated channels. Thus, the UE may monitor the paging on the serving cell. P-RNTI is an abbreviation for paging radio network temporary identifier.

In a second alternative, the UE may monitor for paging and short messages in the USS configured for paging and short messages with the newly indicated TCI state associated with a PCI different from the serving cell. This means that the UE monitors paging on the cell with a different PCI than the serving cell in this alternative. When the UE is indicated with a TCI state for another cell (the serving cell does not change), the UE may be configured to receive at least dedicated channels and/or signals from the other cell. In this case, the UE may not monitor paging (e.g., short message in RRC connected state) on the common search space on the serving cell, but the UE may monitor the paging on USS based on the reference signal indicated by the TCI state of the other cell (i.e., the reference signal is associated with a cell other than the serving cell.

In a third alternative, the UE may monitor for paging and short messages in a type 2 physical downlink control channel (PDCCH) common search space (CSS) configured for paging and short messages with the newly indicated TCI state associated with a PCI different than the serving cell. This is similar to the second alternative, i.e., the paging monitoring assumption is based on the active TCI state for the cell with the different PCI than the serving cell, but the UE performs the paging monitoring on the CSS instead of USS.

The UE may be in RRC connected state or in RRC inactive state, when an RRC connection has been established. If this is not the case (i.e., no RRC connection is established), the UE may be in RRC idle state. For paging monitoring in RRC connected state, the UE may not decode the paging message (i.e., any paging-related physical downlink shared channel, PDSCH), but the UE may monitor the P-RNTI and short messages transmitted over DCI in PDCCH. Short messages may be transmitted on PDCCH using P-RNTI with or without an associated paging message using short message field in DCI format 1_0.

The short message monitored in RRC connected state may comprise a bit to indicate to the UE that the network has modified the system information, and the UE needs to re-acquire the system information. The network may transmit, or broadcast, the system information periodically. In case the short message indicates a system information modification, the UE may acquire the system information from the start of the next modification period. The system information may comprise information such as system frame number, system bandwidth, public land mobile network (PLMN) list, cell identifier, cell selection and re-selection information, timing information, uplink and downlink configuration, etc.

The UE may monitor P-RNTI on a type 2 PDCCH CSS set, which is a common search space. The type 2 PDCCH CSS set may be configured by pagingSearchSpace in PDCCH-ConfigCommon for a DCI format with cyclic redundancy check (CRC) scrambled by a P-RNTI on the primary cell of the master cell group (MCG).

The SearchSpace information element (IE) defines how and/or where to search for PDCCH candidates. A given search space is associated with a control resource set (CORESET). For a scheduled cell in the case of cross-carrier scheduling, except for nrofCandidates, all the optional fields may be absent (regardless of their presence conditions). The common field in the SearchSpace IE may be used to configure this search space as a CSS, and it may also indicate the DCI formats to monitor for. The searchSpaceType field in the SearchSpace IE may indicate whether this search space is a CSS or a USS, as well the DCI formats to monitor for. The ue-Specific field in the SearchSpace IE may be used to configure this search space as a USS.

In inter-cell beam management, a given UE may be configured to monitor paging on a cell with a different PCI than the PCI of the serving cell (referring to the second alternative and the third alternative described above). The paging reception in RRC connected state may be based on the monitoring on CSS, and in some cases (such as the second alternative described above), the UE may receive paging on USS. Paging USS allows potentially targeted paging for inter-cell BM UEs, but it may be inefficient from the system operation perspective in case of multiple UEs in a cell. In order to be able to operate more efficiently, the network may configure USS for paging reception to be the same as CSS, so that all the UEs in the cell can be targeted by using the same message. In this way, the cell may avoid performing additional beam sweeping for paging purposes for different UEs (i.e., the inter-cell BM UEs and the UEs that consider the cell as their serving cell).

If an inter-cell BM UE is configured with a serving-cell-specific or UE-specific paging monitoring for the CORESET on the cell with a different PCI than the serving cell, and the UE monitors paging on the cell with the different PCI, then the cell with the different PCI may need to perform more than one round of beam sweeping for the paging transmission. A first round of beam sweeping may be performed for the UEs that consider the cell with the different PCI as their serving cell, which UEs monitor CSS type 2 (which is the search space monitored for short message/paging) for paging. A second round of beam sweeping may be performed for the inter-cell BM UEs.

In other words, the cell with the different PCI than the serving cell of the inter-cell BM UE may need to transmit paging information separately to inter-cell BM UEs and to the UEs that consider the cell as their serving cell. This may be used to differentiate the cell that the paging was intended for a short message. However, such operation may restrict the network efficiency in terms of throughput and energy consumption, as well as limit the scheduling flexibility, which may limit or reduce the throughput for the UEs in that cell.

Thus, it would be beneficial to provide paging message(s) on a single search space or PDCCH occasion, although seemingly it may be different for different UEs. Considering the above discussion and the provision of paging information in the same message (and time instant), there is an ambiguity whether the paging (short message) delivery is targeted for inter-cell BM UEs or for the UEs that consider the inter-cell BM cell (cell with different PCI than the serving cell of the inter-cell BM UEs) as their serving cell.

In legacy operation (e.g., up to NR Release 16), the paging may only be monitored on the serving cell in RRC connected state, and thus there may be no ambiguity about which cell the received short message applies to (e.g., for which cell the UE should assume the system information modification period). However, for the case of inter-cell beam management, there is a need to provide a mechanism for interpreting the information delivered by the short message, when the UE receives it from some other cell than its serving cell.

Some exemplary embodiments address this need by providing new signaling options and/or interpretation of the bit fields in the short message for example in the case of inter-cell BM operation.

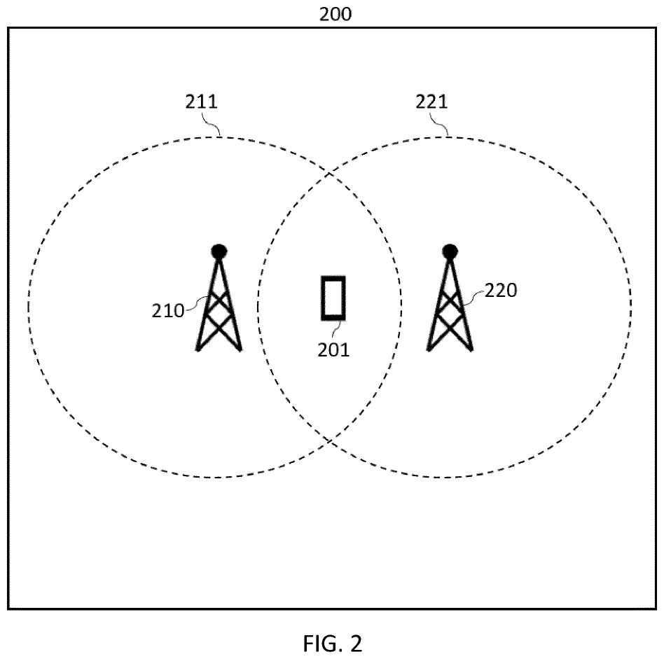

FIG. 2 illustrates one example of a system 200, to which some exemplary embodiments may be applied. Referring to FIG. 2, the system 200 comprises at least one UE 201, a first cell 211 provided by a first network element 210 (e.g., base station or DU), and a second cell 221 provided by a second network element 220 (e.g., base station or DU). Herein the term “cell” refers to a cell of a cellular radio network. The at least one UE 201 may be within the radio coverage of the first cell 211, as well as within the radio coverage of the second cell 221. The first cell 211 is the serving cell of the at least one UE 201, and the second cell 221 is associated with a different PCI than the PCI of the first cell 211. In other words, the second cell 221 is not a serving cell of the at least one UE 201. The at least one UE 201 may be an inter-cell BM UE, which means that the UE may be configured to monitor for paging DCI (e.g., short message) on the second cell 221 via an active inter-cell beam management connection between the at least one UE 201 and the second cell 221.

Herein the terms “first cell” and “second cell” are used to distinguish the cells, and they do not necessarily mean a specific order of the cells.

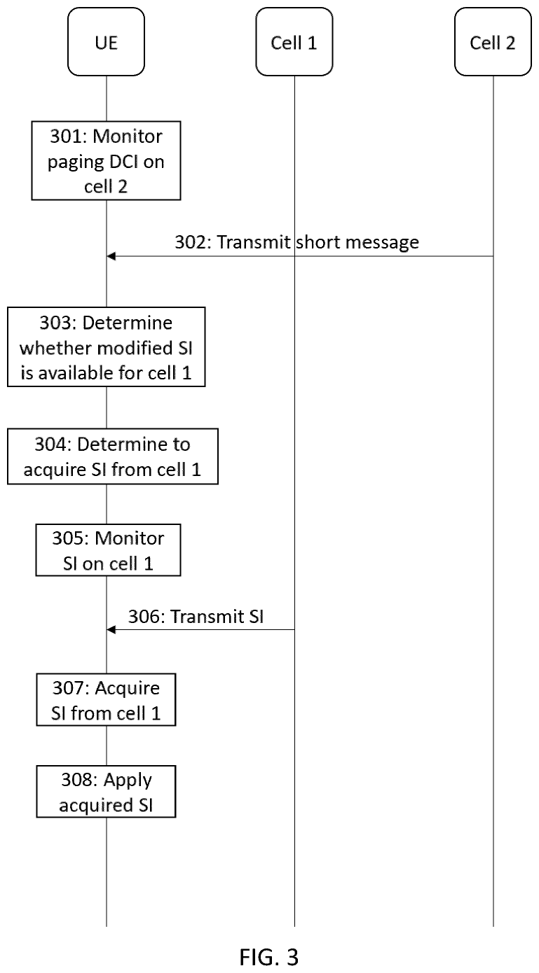

FIG. 3 illustrates a signaling diagram according to an exemplary embodiment. The signaling in FIG. 3 may correspond, for example, to the system 200 illustrated in FIG. 2.

The first cell (cell 1) in FIG. 3 is the serving cell of a UE. The first cell may be controlled by a first network element of a wireless communication network. For example, the first network element may comprise, or be comprised in, a base station or a DU. The second cell (cell 2) in FIG. 3 is a cell with a different PCI than the PCI of the serving cell (first cell) of the UE. In other words, the second cell is not a serving cell of the UE. The second cell may be controlled by a second network element of the wireless communication network, wherein the second network element may be different to the first network element. For example, the second network element may comprise, or be comprised in, a base station or a DU.

Referring to FIG. 3, in step 301, the UE monitors PDCCH for paging DCI (e.g., short message) on the second cell.

In step 302, the second network element controlling the second cell transmits paging DCI to the UE, wherein the paging DCI comprises at least a short message. For example, the second network element may transmit the short message to all UEs (to inter-cell BM UEs as well as UEs that consider the second cell as their serving cell) in the second cell. The UE receives the short message provided by the second cell, while the UE is monitoring for the paging DCI on the second cell. At least one bit field in the short message may comprise a paging-related indication (e.g., related to availability of a system information modification) for the UE, which is monitoring paging on the second cell with the different PCI than the serving cell (first cell) of the UE.

In step 303, the UE determines, based at least partly on the short message, whether a system information (SI) modification is available for the serving cell (first cell). The UE may assume that at least one of the bit fields in the short message comprises a paging-related indication (e.g., referred to as systemInfoModification2 herein) for the serving cell (first cell) of the UE. The system information modification may also be referred to as a system information update.

As an example, when the systemInfoModification2 bit is set to a value of one (1), the UE may assume that a system information modification is available for its serving cell (i.e., for the first cell). In this case, if the systemInfoModification2 bit is not set, or if the systemInfoModification2 bit is set to a value of zero (0), the UE may assume that no system information modification is available for the serving cell.

As an alternative example, when the systemInfoModification2 bit is set to a value of zero (0), the UE may assume that a system information modification is available for its serving cell (i.e., for the first cell). In this case, if the systemInfoModification2 bit is not set, or if the systemInfoModification2 bit is set to a value of one (1), the UE may assume that no system information modification is available for the serving cell.

In step 304, if the short message indicates that a system information modification is available for the serving cell (first cell), then the UE determines to acquire system information from the serving cell (first cell).

In step 305, the UE monitors for the system information on the serving cell (first cell).

In step 306, the first network element controlling the first cell transmits the system information to the UE. For example, the first network element may broadcast the system information to all UEs in the first cell.

In step 307, the UE acquires, or receives, the system information provided by the first cell, while the UE is monitoring for the system information on the first cell. The UE reads the system information and determines what information in the system information has been modified by the first cell.

In step 308, if the UE determines that relevant system information is updated/modified (for the UE), the UE may apply the acquired system information (parameters) for further operation.

In another exemplary embodiment, the first cell and the second cell may be controlled by the same network element (e.g., the same base station or the same DU). Alternatively, the first cell and the second cell may be controlled by different base stations or DUs.

Table 1 below presents an example format for a short message according to an exemplary embodiment (e.g., according to the exemplary embodiment described above with reference to FIG. 3). In other words, Table 1 describes the bits that may be included in the short message. The length (i.e., size) of the short message may be 8 bits in this example. In Table 1, the broadcast control channel (BCCH) modification refers to system information modification. Bit 1 may be the most significant bit of the short message in this example. In this example, the fourth bit in the short message may indicate the systemInfoModification2.

TABLE 1

| Bit | Short message |
|---|---|
| 1 | systemInfoModification |
| | If set to 1: indication of a BCCH |
| | modification other than SIB6, SIB7 and |
| | SIB8. |
| 2 | etwsAndCmasIndication |
| | If set to 1: indication of an ETWS |
| | primary notification and/or an ETWS |
| | secondary notification and/or a CMAS |
| | notification. |
| 3 | stopPagingMonitoring |
| | This bit can be used for only operation |
| | with shared spectrum channel access |
| | and if nrofPDCCH- |
| | MonitoringOccasionPerSSB-InPO is |
| | present. |
| | If set to 1: indication that the UE may |
| | stop monitoring PDCCH occasion(s) |
| | for paging in this Paging Occasion. |
| 4 | systemInfoModification2 |
| | If set to 1: indication of a BCCH |
| | modification in the serving cell, other |
| | than SIB6, SIB7 and SIB8, for the UE |
| | monitoring paging on cell with |
| | different PCI than serving cell. |
| 5-8 | Not used in this example, and may be |
| | ignored by UE if received. |

In another exemplary embodiment, if the UE is monitoring paging DCI (e.g., short message) on the serving cell (first cell), the UE may read the bit fields in the short message according to legacy operation (e.g., bit 1 is for systemInfoModification, bit 2 is for etwsAndCmasIndication, etc). This way, the legacy UE operation is not changed, when the UE monitors paging DCI on its serving cell

Table 2 below presents an example format for a short message according to an exemplary embodiment, wherein the UE ignores systemInfoModification2, if the UE is monitoring paging DCI on its serving cell (instead of the cell with the different PCI than the serving cell).

TABLE 2

| Bit | Short message |
|---|---|
| 1 | systemInfoModification |
| | If set to 1: indication of a BCCH |
| | modification other than SIB6, SIB7 and |
| | SIB8. |
| 2 | etwsAndCmasIndication |
| | If set to 1: indication of an ETWS |
| | primary notification and/or an ETWS |
| | secondary notification and/or a CMAS |
| | notification. |
| 3 | stopPagingMonitoring |
| | This bit can be used for only operation |
| | with shared spectrum channel access |
| | and if nrofPDCCH- |
| | MonitoringOccasionPerSSB-InPO is |
| | present. |
| | If set to 1: indication that the UE may |
| | stop monitoring PDCCH occasion(s) |
| | for paging in this Paging Occasion. |
| 4 | systemInfoModification2 |
| | If set to 1: indication of a BCCH |
| | modification in the serving cell, other |
| | than SIB6, SIB7 and SIB8, for the UE |
| | monitoring paging on cell with |
| | different PCI than serving cell. This bit |
| | field is ignored if UE monitors the |
| | paging on its serving cell. |
| 5-8 | Not used in this example, and may be |
| | ignored by UE if received. |

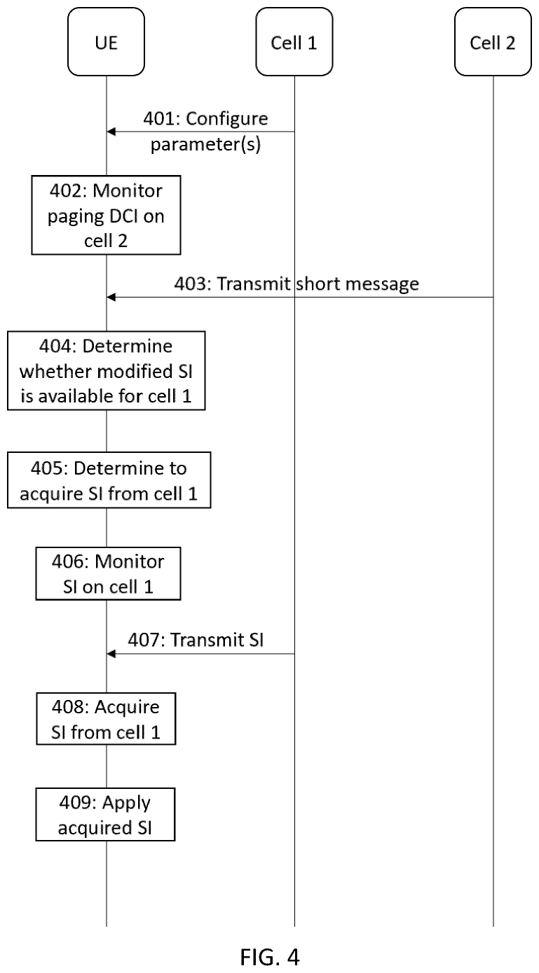

FIG. 4 illustrates a signaling diagram according to another exemplary embodiment, wherein the UE may be pre-configured with one or more higher layer parameters (e.g., RRC), which may control the UE's interpretation of the bit fields in the short message received in a cell with a different PCI than the PCI of the serving cell of the UE. The signaling in FIG. 4 may correspond, for example, to the system 200 illustrated in FIG. 2.

Referring to FIG. 4, in step 401, a first network element controlling a first cell (cell 1) configures, or transmits, one or more parameters to a UE for example via RRC. The first cell is the serving cell of the UE. The first cell may be controlled by a first network element of a wireless communication network. For example, the first network element may comprise, or be comprised in, a base station or a DU.

The one or more parameters may be used to control how the UE interprets the bit fields in short messages received from a cell with a different PCI than the serving cell of the UE. The one or more parameters may also be referred to as higher layer parameters herein. For example, the higher layer may refer to RRC.

As an example, the one or more parameters may comprise at least a first parameter indicating a bit position that the UE should monitor for a paging-related indication in short messages, when the paging is monitored on a cell with a different PCI than the serving cell. In other words, the first parameter may indicate which bit in the short message indicates whether a system information modification (i.e., a system information update) is available for the serving cell (the first cell). As a non-limiting example, the first parameter may be referred to as pagingIndicationServingCell herein.

Alternatively or additionally, the one or more parameters may comprise at least a second parameter indicating whether or not to monitor for short messages in the cell with the different PCI than the serving cell.

Herein the terms “first parameter” and “second parameter” are used to distinguish the parameters, and they do not necessarily mean a specific order of the parameters.

In step 402, the UE monitors PDCCH for paging DCI (e.g., short message) on a second cell (cell 2) controlled by a second network element of the wireless communication network. The second cell is associated with a different PCI than the PCI of the serving cell of the UE. In other words, the second cell is not a serving cell of the UE. For example, the second network element may comprise, or be comprised in, a base station or a DU.

In step 403, the second network element controlling the second cell transmits the paging DCI to the UE, wherein the paging DCI comprises at least a short message. For example, the second network element may transmit the short message to all UEs (to inter-cell BM UEs as well as UEs that consider the second cell as their serving cell) in the second cell. The UE receives the short message provided by the second cell, while the UE is monitoring for the paging DCI on the second cell. At least one bit field in the short message may comprise a paging-related indication (e.g., related to availability of a system information modification) for the UE, which is monitoring paging on the second cell with the different PCI than the serving cell (first cell) of the UE.

In step 404, the UE determines, based at least partly on the short message and the one or more parameters (configured in step 401), whether a system information (SI) modification is available for the serving cell (first cell). If the one or more parameters were pre-configured in step 401, the UE may assume that at least one of the bit fields in the short message comprises a paging-related indication (e.g., referred to as systemInfoModification2 herein) for the serving cell (first cell) of the UE.

In one example, the UE may assume that the short message carries information for the serving cell paging, if at least one higher layer parameter (e.g., pagingIndicationServingCell) has been configured to the UE in step 401. If no higher layer parameter is configured, the UE may assume that no (additional) bit field for the serving cell (first cell) is present in the short message, and the UE may assume the paging monitoring so that when a bit field (e.g., the systemInfoModification) is set (e.g., to 1) in the short message, it applies for the serving cell of the UE (instead of the second cell that provided the short message). In other words, the UE may assume that if there is no systemInfoModification2 bit field in the short message (e.g., the UE is not configured to interpret/read the bit/value), the legacy systemInfoModification field applies (i.e., indicates SI modification) for the serving cell (first cell) of the UE (and not the second cell with the different PCI that provided the short message).

Alternatively, in another example, the network (e.g., the serving cell) may configure the UE with a parameter that makes the UE interpret the systemInfoModification bit field in the short message to indicate serving cell (first cell) information (e.g., when the UE is monitoring paging/short message on the second cell with the different PCI than the serving cell). This configuration may further be associated with the specific search space ID or CORESET ID, where the UE monitors paging information (short message). If the network does not provide the configuration to interpret the systemInfoModification as serving cell paging, the UE may monitor paging on the serving cell (instead of the second cell with the different PCI).

Alternatively, the at least one higher layer parameter (e.g., pagingIndicationServingCell) may indicate whether the UE assumes the serving cell information to be indicated by the legacy bit fields (e.g., systemInfoModification), or whether the UE assumes a separate bit field (e.g., systemInfoModification2) in the short message to indicate whether information for the serving cell of the UE is indicated.

For example, if the at least one higher-layer parameter is configured and the systemInfoModification2 bit in the short message is set to a value of 1, the UE may assume that a system information modification is available for its serving cell (i.e., for the first cell). In this case, if the systemInfoModification2 bit is not set, or if the systemInfoModification2 bit is set to a value of 0, or if no higher-layer parameter is configured, the UE may assume that no system information modification is available for the serving cell.

In one example, if no higher-layer parameter (e.g., systemInfoModification2) is configured, the UE may assume systemInfoModification to provide an indication that a system information modification is available for the serving cell (instead of the second cell that provided the short message).

As another example, a specific bit field in the short message may indicate whether there is a paging-related indication (e.g., related to system information modification) provided on at least one serving cell of a plurality serving cells. Based on this bit field, the UE may assume that its respective serving cell (the first cell) has a system information modification available, and that the UE is required to re-acquire the system information from the first cell. For example, if the second cell (PCI2) is an inter-cell BM cell for UEs served by the first cell (PCI1) and a third cell (PCI3), the UEs of PCI1 and PCI3 may receive a paging-related indication in the specific bit field in the short message. Thus, the UE may assume, when the bit field is set to a specific value (e.g., to 1), that a system information modification is available for its serving cell.

In step 405, if the short message indicates that a system information modification is available for the serving cell (first cell), then the UE determines to acquire system information from the serving cell (first cell).

In step 406, the UE monitors for the system information on the serving cell (first cell).

In step 407, the first network element controlling the first cell transmits the system information to the UE. For example, the first network element may broadcast the system information to all UEs in the first cell.

In step 408, the UE acquires, or receives, the system information provided by the first cell, while the UE is monitoring for the system information on the first cell. The UE reads the system information provided by the first cell and determines what information in the system information has been modified.

In step 409, if the UE determines that relevant system information is updated/modified (for the UE), the UE may apply the acquired system information (parameters) for further operation.

Table 3 below presents an example format for a short message according to an exemplary embodiment (e.g., according to the exemplary embodiment described above with reference to FIG. 4).

TABLE 3

| Bit | Short message |
|---|---|
| 1 | systemInfoModification |
| | If set to 1: indication of a BCCH |
| | modification other than SIB6, SIB7 and |
| | SIB8. |
| 2 | etwsAndCmasIndication |
| | If set to 1: indication of an ETWS |
| | primary notification and/or an ETWS |
| | secondary notification and/or a CMAS |
| | notification. |
| 3 | stopPagingMonitoring |
| | This bit can be used for only operation |
| | with shared spectrum channel access |
| | and if nrofPDCCH- |
| | MonitoringOccasionPerSSB-InPO is |
| | present. |
| | If set to 1: indication that the UE may |
| | stop monitoring PDCCH occasion(s) |
| | for paging in this Paging Occasion. |
| 4 | systemInfoModification2 |
| | If set to 1: indication of a BCCH |
| | modification in one of the serving |
| | cells, other than SIB6, SIB7 and SIB8, |
| | for the UEs monitoring paging on cell |
| | with different PCI than serving cell. |
| 5-8 | Not used in this example, and may be |
| | ignored by UE if received. |

In another exemplary embodiment, when the UE is monitoring paging DCI on a cell with a different PCI than the PCI of its serving cell, the only bit field that is read from the short message by the UE may be the systemInfoModification2, which indicates whether a system information modification is available for the serving cell of the UE.

In another exemplary embodiment, in addition to or alternatively to the previous exemplary embodiments, the short message may comprise a paging-related indication for one or more PCI lists configured for the specific bit field indication. A given PCI list may comprise a list of one or more PCIs associated with one or more cells (one PCI per cell). In this exemplary embodiment, the UE may be configured with one or more parameters (e.g., via RRC) indicating a bit position in the short message, wherein the bit position is associated with one of the one or more PCI lists. In other words, a given PCI list may be associated with a specific bit in the short message. The one or more PCI lists and the one or more parameters may be configured to the UE for example via RRC by the serving cell. For example, a parameter called “servingcell list1 for paging” may be used to indicate a first PCI list, and/or a parameter called “servingcell list2 for paging” may be used to indicate a second PCI list. In this manner, it is possible to indicate one or more specific cells that have a system information modification that needs to be acquired by UEs that consider that cell to be their serving cell. If the bit field associated with the serving cell PCI for the UE is set to a value of 1 (to indicate paging information for the serving cell), then this may indicate that the UE is required to acquire the system information from the serving cell. If there is more than one cell in the PCI list, it may indicate that one of the cells has a system information modification available, but the UE may not be able to determine the specific cell, and is thus required to at least check whether the system information has been modified.

Table 4 below presents an example format for a short message according to the exemplary embodiment described above. Any of the bit fields herein may be subject to higher layer (e.g., RRC) configuration.

TABLE 4

| Bit | Short message |
|---|---|
| 1 | systemInfoModification |
| | If set to 1: indication of a BCCH |
| | modification other than SIB6, SIB7 and |
| | SIB8. |
| 2 | etwsAndCmasIndication |
| | If set to 1: indication of an ETWS |
| | primary notification and/or an ETWS |
| | secondary notification and/or a CMAS |
| | notification. |
| 3 | stopPagingMonitoring |
| | This bit can be used for only operation |
| | with shared spectrum channel access |
| | and if nrofPDCCH- |
| | MonitoringOccasionPerSSB-InPO is |
| | present. |
| | If set to 1: indication that the UE may |
| | stop monitoring PDCCH occasion(s) |
| | for paging in this Paging Occasion. |
| 4 | systemInfoModification2 |
| | If set to 1: indication of a BCCH |
| | modification in one of the serving cells |
| | indicated by a parameter “servingcell |
| | list1 for paging”, other than SIB6, SIB7 |
| | and SIB8, for the UEs monitoring |
| | paging on cell with different PCI than |
| | serving cell. |
| 5 | systemInfoModification2 |
| | If set to 1: indication of a BCCH |
| | modification in one of the serving cells |
| | indicated by a parameter “servingcell |
| | list2 for paging”, other than SIB6, SIB7 |
| | and SIB8, for the UEs monitoring |
| | paging on cell with different PCI than |
| | serving cell. |
| 6-8 | Not used in this example, and may be |
| | ignored by UE if received. |

In another exemplary embodiment, the short message may comprise one or more cell-specific bits (one bit per cell) indicating whether a system information modification is available for a specific cell. In other words, a respective bit field in the short message may be assigned for one or more specific cells. For example, a first bit in the short message may be assigned for a first cell (PCI1), and a second bit in the short message may be assigned for a second cell (PCI2). It should be noted that the terms “first bit” and “second bit” are used herein to distinguish the bits, and they do not necessarily mean a specific position of the bits in the short message. The serving cell may configure the UE (e.g., via RRC) with a parameter indicating the bit position that the UE should monitor in the short message. The UE, based on the configuration, monitors the configured bit field in the short message to determine whether its serving cell has a system information modification available. This may be further conditioned with the presence of a higher layer parameter, or when a higher layer parameter indicates it. The bit field monitoring may be performed, when paging is not monitored on the serving cell (e.g., when paging is monitored on a cell with different PCI than the serving cell).

In another exemplary embodiment, if at least one bit in the message is set to a specific value, this may indicate to the UE that a system information modification is available for the serving cell, when the UE is monitoring paging DCI (e.g., short message) on a cell with a different PCI than its serving cell. For example, if a bit in the short message is set to a value of 1, this may indicate that a system information modification is available for the serving cell. A parameter may be configured for example via RRC to control whether the UE assumes the information in the short message to be interpreted for the serving cell, for example when the UE is monitoring the paging DCI (e.g., short message) on the cell with a different PCI than its serving cell. The bit position that the UE reads to determine whether the paging is for the serving cell may be configured by RRC, or the RRC may configure whether the UE reads a specific bit position or bit field in the short message to determine whether a system information modification is available (i.e., an SI update is required) for the serving cell. Alternatively or additionally, the RRC may configure the UE to interpret each bit field (bit position) in the short message to be for the serving cell. The bit position may be the same as in a legacy short message, but the RRC control may used for controlling the UE's interpretation of the bit fields. Alternatively, any of the bit fields in the short message may be subject to the PCI indicated by the reference signal of the active TCI state for the CORESET.

In another exemplary embodiment, when a UE is monitoring paging DCI (e.g., short message) on a cell with a different PCI than its serving cell, the UE may assume that if any of the bits in the short message is set to 1, then this indicates that the information in the short message is valid for its serving cell (and not the cell that provided the short message). This may be configurable by the network. For example, if a specific parameter (e.g., configured to the UE by the network via RRC) is present or set, the UE may assume that at least one indicated field in the short message applies for the serving cell of the UE. As an example, if systemInfoModification is set to 1, then the UE assumes that a system information modification is available for its serving cell, and the UE may acquire the system information.

In another exemplary embodiment, if the short message indicates the etwsAndCmasIndication (e.g., if the respective bit is set to 1), the UE may be required, regardless of whether it monitors paging on a cell with a different PCI than the serving cell, or regardless of the higher layer parameter(s), to read the SIB1 of the serving cell and acquire relevant system information blocks (SIBs) indicated by the si-SchedulingInfo for the warning information (e.g., ETWS or CMAS notification). This may depend on whether UE is capable of interpreting ETWS and/or CMAS notifications. In one example, if the short message indicates etwsAndCmasIndication, the UE may obtain the corresponding SIBs from the cell with the different PCI than the serving cell, for example from the cell where the UE received the short message (from the cell that provided the short message).

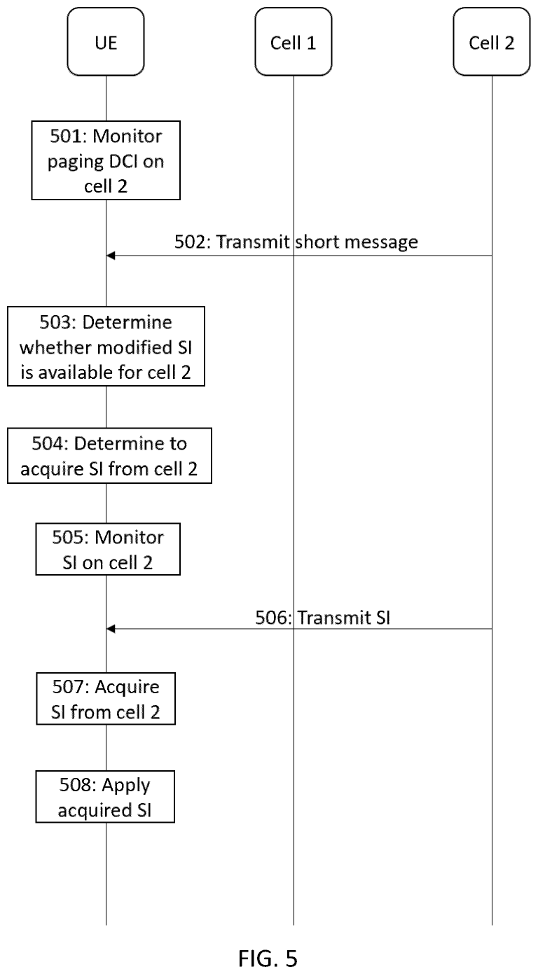

FIG. 5 illustrates a signaling diagram according to another exemplary embodiment, wherein a UE may be configured to pre-emptively obtain system information on the cell that provided the short message indicating systemInfoModification. Instead of monitoring the system information only on the serving cell, in this exemplary embodiment, the UE may determine to obtain the relevant modified system information for the UE operation from the cell that provided the short message (which is not the serving cell of the UE). In other words, the UE may be configured to acquire the system information from the cell with a different PCI than the serving cell of the UE, if the UE has been configured with a mobility-specific configuration. This may provide a benefit of reducing the handover and/or beam failure recovery latency.

The first cell (cell 1) in FIG. 5 is the serving cell of the UE. The first cell may be controlled by a first network element of a wireless communication network. For example, the first network element may comprise, or be comprised in, a base station or a DU. The second cell (cell 2) in FIG. 5 is a cell with a different PCI than the PCI of the serving cell (first cell) of the UE. In other words, the second cell is not a serving cell of the UE. The second cell may be controlled by a second network element of the wireless communication network, wherein the second network element may be different to the first network element. For example, the second network element may comprise, or be comprised in, a base station or a DU.

Referring to FIG. 5, in step 501, the UE monitors PDCCH for paging DCI (e.g., short message) on the second cell.

In step 502, the second network element controlling the second cell transmits paging DCI to the UE, wherein the paging DCI comprises at least a short message. For example, the second network element may transmit the short message to all UEs (to inter-cell BM UEs as well as UEs that consider the second cell as their serving cell) in the second cell. The UE receives the short message provided by the second cell, while the UE is monitoring for the paging DCI on the second cell. At least one bit field in the short message may comprise a paging-related indication (e.g., related to availability of a system information modification) for the UE, which is monitoring paging on the second cell with the different PCI than the serving cell (first cell) of the UE.

In step 503, the UE determines, based at least partly on the short message, whether a system information (SI) modification is available for the second cell. The UE may assume that at least one of the bit fields in the short message comprises a paging-related indication (e.g., referred to as systemInfoModification herein) for the second cell. The system information modification may also be referred to as a system information update.

As an example, when the systemInfoModification bit is set to a value of 1, the UE may assume that a system information modification is available for the second cell. In this case, if the systemInfoModification bit is not set, or if the systemInfoModification bit is set to a value of 0, the UE may assume that no system information modification is available for the second cell.

As an alternative example, when the systemInfoModification bit is set to a value of 0, the UE may assume that a system information modification is available for the second cell. In this case, if the systemInfoModification bit is not set, or if the systemInfoModification bit is set to a value of 1, the UE may assume that no system information modification is available for the second cell.

In step 504, if the short message indicates that a system information modification for the second cell is available, the UE determines, for example based on a conditional handover (CHO) configuration for the second cell, or an L1/L2-centric mobility configuration for the second cell, or a beam failure recovery configuration for the second cell, to acquire system information from the second cell.

As an example, the UE may be configured to perform a conditional handover to a target cell (e.g., the second cell) based on one or more conditions, i.e., without an explicit handover command from the network. The CHO target cell (e.g., the second cell) may be configured for the UE by the network (e.g., by the first cell), and the UE may acquire the (updated) SI for the CHO target cell (e.g., for the second cell) based on the indication in the short message.

Similarly, in case the second cell is configured for beam failure recovery target, the UE may recover to the target cell (the second cell), if a beam failure occurs in the serving cell (first cell). The UE may acquire the (updated) SI for the target cell (second cell) based on the indication in the short message. This may shorten the latency for accessing the target cell (second cell), since the UE may already have up-to-date SI for it.

In step 505, the UE monitors for the system information on the second cell.

In step 506, the second network element controlling the second cell transmits the system information to the UE. For example, the second network element may broadcast the system information to all UEs in the second cell.

In step 507, the UE acquires, or receives, the system information provided by the second cell, while the UE is monitoring for the system information on the second cell. The UE reads the system information provided by the second cell and determines what information in the system information has been modified by the second cell.

In step 508, if the UE determines that relevant system information is updated/modified (for the UE), the UE may apply the acquired system information (parameters) for further operation.

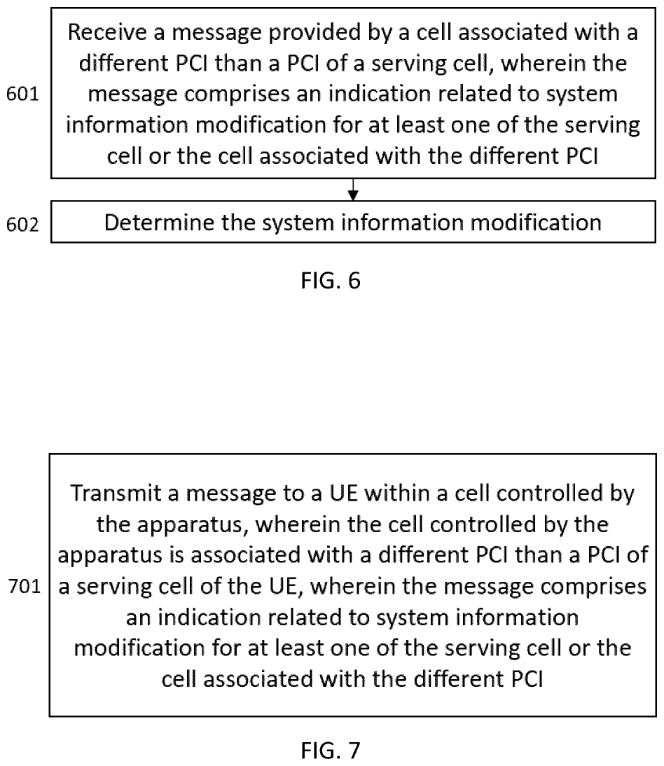

FIG. 6 illustrates a flow chart according to an exemplary embodiment. The steps illustrated in FIG. 6 may be performed by an apparatus such as, or comprised in, a terminal device (e.g., the UE 201 of FIG. 2). Herein a terminal device may also be referred to as a UE or user equipment.

Referring to FIG. 6, in step 601, a message provided by a cell associated with a different physical cell identifier (PCI) than a physical cell identifier of a serving cell of the apparatus is received, wherein the message comprises an indication related to system information modification for at least one of the serving cell and/or the cell associated with the different physical cell identifier. The message may be a short message, for example.

In step 602, the apparatus determines, based at least partly on the message, the system information modification for at least one of the serving cell and/or the cell associated with the different physical cell identifier. In other words, the apparatus determines whether a system information modification is available for at least one of the serving cell and/or the cell associated with the different physical cell identifier.

FIG. 7 illustrates a flow chart according to an exemplary embodiment. The steps illustrated in FIG. 7 may be performed by an apparatus such as, or comprised in, a network element of a wireless communication network (e.g., the second network element 220 of FIG. 2).

Referring to FIG. 7, in step 701, a message is transmitted to a terminal device (e.g., inter-cell BM UE) that is within a cell controlled by the apparatus, wherein the cell controlled by the apparatus is associated with a different physical cell identifier (PCI) than a physical cell identifier of a serving cell of the terminal device, wherein the message comprises an indication related to system information modification for at least one of the serving cell and/or the cell associated with the different physical cell identifier. For example, the apparatus may transmit the message to all terminal devices within the cell controlled by the apparatus, wherein one or more of the terminal devices may be inter-cell BM UEs and one or more of the terminal devices may have the cell controlled by the apparatus as their serving cell. The message may be a short message, for example.

The steps and/or blocks described above by means of FIGS. 3-7 are in no absolute chronological order, and some of them may be performed simultaneously or in an order differing from the described one. Other steps and/or blocks may also be executed between them or within them.

A technical advantage provided by some exemplary embodiments is that they may may improve the network efficiency in terms of throughput and energy consumption, as well as improve the scheduling flexibility, which may improve the throughput for the UEs in the cell.

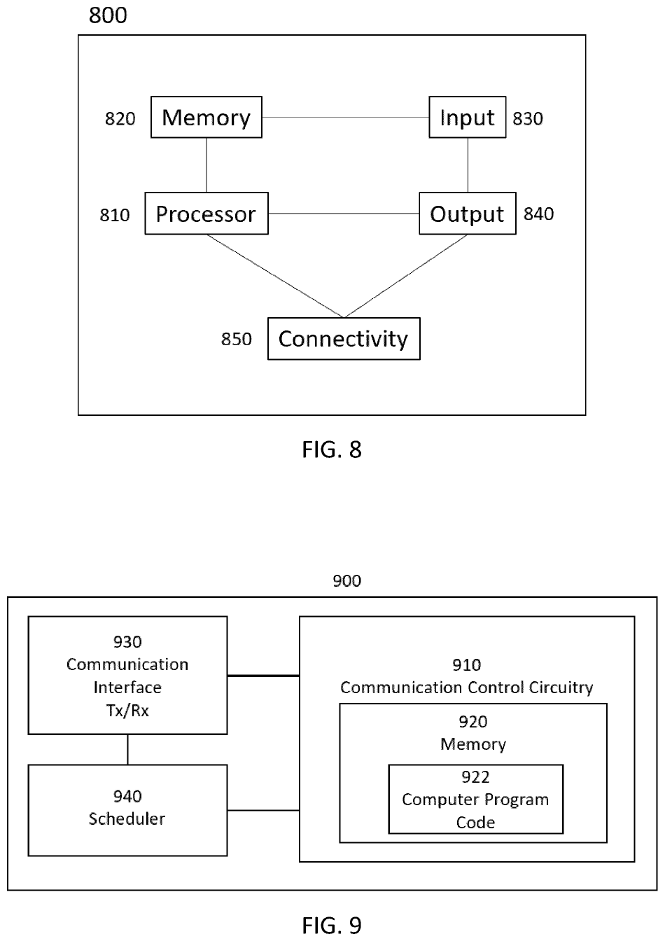

FIG. 8 illustrates an apparatus 800, which may be an apparatus such as, or comprised in, a terminal device, according to an exemplary embodiment. The terminal device may also be referred to as a UE or user equipment herein. The apparatus 800 comprises a processor 810. The processor 810 interprets computer program instructions and processes data. The processor 810 may comprise one or more programmable processors. The processor 810 may comprise programmable hardware with embedded firmware and may, alternatively or additionally, comprise one or more application-specific integrated circuits (ASICs).

The processor 810 is coupled to a memory 820. The processor is configured to read and write data to and from the memory 820. The memory 820 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 820 stores computer readable instructions that are executed by the processor 810. For example, non-volatile memory stores the computer readable instructions and the processor 810 executes the instructions using volatile memory for temporary storage of data and/or instructions.

The computer readable instructions may have been pre-stored to the memory 820 or, alternatively or additionally, they may be received, by the apparatus, via an electromagnetic carrier signal and/or may be copied from a physical entity such as a computer program product. Execution of the computer readable instructions causes the apparatus 800 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 800 may further comprise, or be connected to, an input unit 830. The input unit 830 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 830 may comprise an interface to which external devices may connect to.

The apparatus 800 may also comprise an output unit 840. The output unit may comprise or be connected to one or more displays capable of rendering visual content, such as a light emitting diode (LED) display, a liquid crystal display (LCD) and/or a liquid crystal on silicon (LCoS) display. The output unit 840 may further comprise one or more audio outputs. The one or more audio outputs may be for example loudspeakers.

The apparatus 800 further comprises a connectivity unit 850. The connectivity unit 850 enables wireless connectivity to one or more external devices. The connectivity unit 850 comprises at least one transmitter and at least one receiver that may be integrated to the apparatus 800 or that the apparatus 800 may be connected to. The at least one transmitter comprises at least one transmission antenna, and the at least one receiver comprises at least one receiving antenna. The connectivity unit 850 may comprise an integrated circuit or a set of integrated circuits that provide the wireless communication capability for the apparatus 800. Alternatively, the wireless connectivity may be a hardwired application-specific integrated circuit (ASIC). The connectivity unit 850 may comprise one or more components such as a power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 800 may further comprise various components not illustrated in FIG. 8. The various components may be hardware components and/or software components.

The apparatus 900 of FIG. 9 illustrates an exemplary embodiment of an apparatus such as, or comprised in, a network element of a wireless communication network. The network element may also be referred to, for example, as a network node, a RAN node, a NodeB, an LTE evolved NodeB (eNB), a gNB, a base station, an NR base station, a 5G base station, an access node, an access point (AP), a distributed unit (DU), a central unit (CU), a baseband unit (BBU), a radio unit (RU), a radio head, a remote radio head (RRH), or a transmission and reception point (TRP). The apparatus 900 may comprise, for example, a circuitry or a chipset applicable for realizing some of the described exemplary embodiments. The apparatus 900 may be an electronic device comprising one or more electronic circuitries. The apparatus 900 may comprise a communication control circuitry 910 such as at least one processor, and at least one memory 920 including a computer program code (software) 922 wherein the at least one memory and the computer program code (software) 922 are configured, with the at least one processor, to cause the apparatus 900 to carry out some of the exemplary embodiments described above.

The processor is coupled to the memory 920. The processor is configured to read and write data to and from the memory 920. The memory 920 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 920 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

The memory 920 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 900 may further comprise a communication interface 930 comprising hardware and/or software for realizing communication connectivity according to one or more communication protocols. The communication interface 930 comprises at least one transmitter (Tx) and at least one receiver (Rx) that may be integrated to the apparatus 900 or that the apparatus 900 may be connected to. The communication interface 930 provides the apparatus with radio communication capabilities to communicate in the cellular communication system. The communication interface may, for example, provide a radio interface to terminal devices. The apparatus 900 may further comprise another interface towards a core network such as the network coordinator apparatus and/or to the access nodes of the cellular communication system. The apparatus 900 may further comprise a scheduler 940 that is configured to allocate resources.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1-17. (canceled)

18. An apparatus comprising at least one processor, and at least one memory including computer program code, wherein the at least one memory and the computer program code are configured, with the at least one processor, to cause the apparatus to:
receive a message provided from a cell associated with a different physical cell identifier than a physical cell identifier of a serving cell of the apparatus, wherein the message comprises an indication related to system information modification for at least one of the serving cell or the cell associated with the different physical cell identifier; and
determine, based at least partly on the message, the system information modification for at least one of the serving cell or the cell associated with the different physical cell identifier.

19. An apparatus according to claim 18, wherein the apparatus is further caused to:
acquire system information provided from the serving cell, in response to the determination of the system information modification for the serving cell.

20. An apparatus according to claim 18, wherein the apparatus is further caused to:
acquire system information provided from the cell associated with the different physical cell identifier than the physical cell identifier of the serving cell, in response to the determination of the system information modification for the cell associated with the different physical cell identifier.

21. An apparatus according to claim 20, wherein the apparatus is further caused to:
determine, based at least partly on a configuration, to acquire the system information provided from the cell associated with the different physical cell identifier than the physical cell identifier of the serving cell.

22. An apparatus according to claim 18, wherein the apparatus is further caused to:
receive one or more parameters related to the message, wherein the one or more parameters are provided from the serving cell; and
determine, based at least partly on the message and the one or more parameters, the system information modification for the serving cell.

23. An apparatus according to claim 22, wherein the one or more parameters indicate one or more bit positions for the indication related to the system information modification for the serving cell.

24. An apparatus according to claim 18, wherein the indication is for a list of one or more physical cell identifiers associated with one or more cells, wherein the one or more cells comprise at least the serving cell.

25. An apparatus according to claim 18, wherein the message comprises one or more cell-specific bits related to the system information modification.

26. An apparatus according to claim 25, wherein the one or more cell-specific bits comprise at least one bit related to the system information modification for the serving cell.

27. An apparatus according to claim 18, wherein the apparatus is further caused to:
determine the system information modification for the serving cell, in response to at least one bit in the message being set to a value.

28. An apparatus according to claim 18, wherein the apparatus is further caused to:
monitor paging downlink control information provided from the cell associated with the different physical cell identifier than the physical cell identifier of the serving cell, wherein the paging downlink control information comprises at least the message, and wherein the message is received during the monitoring via an active inter-cell beam management connection to the cell associated with the different physical cell identifier.

29. An apparatus comprising at least one processor, and at least one memory including computer program code, wherein the at least one memory and the computer program code are configured, with the at least one processor, to cause the apparatus to:
transmit a message to a terminal device within a cell controlled by the apparatus, wherein the cell controlled by the apparatus is associated with a different physical cell identifier than a physical cell identifier of a serving cell of the terminal device, wherein the message comprises an indication related to system information modification for at least one of the serving cell or the cell associated with the different physical cell identifier.

30. A method comprising:
receiving, by a terminal device, a message provided from a cell associated with a different physical cell identifier than a physical cell identifier of a serving cell of the terminal device, wherein the message comprises an indication related to system information modification for at least one of the serving cell or the cell associated with the different physical cell identifier; and
determining, by the terminal device, based at least partly on the message, the system information modification for at least one of the serving cell or the cell associated with the different physical cell identifier.

31. A method according to claim 30, further comprising:
acquiring system information provided from the serving cell, in response to the determination of the system information modification for the serving cell.

32. A method according to claim 30, further comprising:
acquiring system information provided from the cell associated with the different physical cell identifier than the physical cell identifier of the serving cell, in response to the determination of the system information modification for the cell associated with the different physical cell identifier.

33. A method according to claim 32, further comprising:
determining, based at least partly on a configuration, to acquire the system information provided from the cell associated with the different physical cell identifier than the physical cell identifier of the serving cell.

34. A method according to claim 30, further comprising:
receiving one or more parameters related to the message, wherein the one or more parameters are provided from the serving cell; and
determining, based at least partly on the message and the one or more parameters, the system information modification for the serving cell.

35. A method comprising:
transmitting, by a network element of a wireless communication network, a message to a terminal device within a cell controlled by the network element, wherein the cell controlled by the network element is associated with a different physical cell identifier than a physical cell identifier of a serving cell of the terminal device, wherein the message comprises an indication related to system information modification for at least one of the serving cell or the cell associated with the different physical cell identifier.

36. A computer program comprising instructions for causing an apparatus to perform at least the following:
receiving a message provided from a cell associated with a different physical cell identifier than a physical cell identifier of a serving cell of the apparatus, wherein the message comprises an indication related to system information modification for at least one of the serving cell or the cell associated with the different physical cell identifier; and
determining, based at least partly on the message, the system information modification for at least one of the serving cell or the cell associated with the different physical cell identifier.

37. A computer program comprising instructions for causing an apparatus to perform at least the following:
transmitting a message to a terminal device within a cell controlled by the apparatus, wherein the cell controlled by the apparatus is associated with a different physical cell identifier than a physical cell identifier of a serving cell of the terminal device, wherein the message comprises an indication related to system information modification for at least one of the serving cell or the cell associated with the different physical cell identifier.
